(19) United States
(12) Patent Application Publication
(10) Pub. No.: US 2010/0039384 A1
(43) Pub. Date: Feb. 18, 2010

(54) FOOT PAD STRUCTURE OF A MOUSE

(75) Inventor: Kuan-Ting Chen, Kaohsiung City (TW)

Correspondence Address: APEX JURIS, PLLC, 12733 LAKE CITY WAY NORTHEAST, SEATTLE, WA, 98125, US

(73) Assignee: ARESON TECHNOLOGY CORP., Sanchong City (TW)

(21) Appl. No.: 12/192,864

(22) Filed: Aug. 15, 2008

(51) Int. Cl. G09G 5/08

(52) U.S. Cl. 345/163

(57) ABSTRACT

The present invention discloses an improved foot pad structure of a mouse, including: a mouse housing, having a top surface and a bottom surface; at least one foot pad, disposed on a bottom surface of the mouse housing, and made of a ceramic material or a glass material for providing wear-resisting, low friction, low worn-out features as well as an easy sliding operation while sliding on a plane, so as to give a smooth movement with a better displacement operability, and enhance practicability, cost effectiveness and product competitiveness.

### BACKGROUND OF THE INVENTION

1. Field of the Invention

The present invention relates to a mouse structure, and more particularly to an improved foot pad structure of a mouse with the features of a low friction, a low worn-out and an easy sliding operation.

2. Description of the Related Art

In existing computer execution processes, a mouse is usually used for clicking an icon on a screen for performing an operation, and a roller or an optical mechanism of the mouse is used for responding to moving data. To facilitate a smooth movement of the mouse, a mouse pad is generally used for the operation to achieve a smooth sliding or rolling of the mouse. Since frictions are produced between the mouse and the mouse pad frequently, a contact surface of the mouse or the mouse pad is worn out easily, and thus affecting the operating performance of the mouse. To improve the foregoing drawback, related patents including R.O.C. Utility Model Pat. No. 275475 entitled “Mouse pad” are disclosed for overcoming the issue of misjudgments made by a mouse due to a rough surface of the mouse pad. The mouse pad of the issued patent comprises: a glass substrate and a surface layer, and the surface layer has a ceramic material formed on a glass substrate, and a plurality of crevices, and the roughness of the surface layer falls within a range of 1˜20 μm. Although the technology of mouse pads can achieve the required precision and function of a mouse operation, the problem has not been solved yet, since a ceramic mouse pad absorbs a portion of light source and causes a possible misjudgment of a moving signal. Since the design for signal feedbacks of the mouse is relatively precise and well-developed, the mouse can fully receive and respond to a moving signal generated by a displacement of the mouse. In addition to the add-on functions of the mouse, the gripping and the displacement operability of a mouse are key points of the design of the existing mice, and the displacement operability of a mouse is reflected directly by foot pads at the bottom of the mouse. Since a mouse pad usually becomes an obstacle on a desktop and a limitation of the sliding operation, computer users often give up the use of a mouse pad, but operate the mouse directly on a desktop (or a glass pad) instead, and most notebook computer users do not carry a mouse pad with them, and thus notebook computer users usually do not use mouse pads. To overcome the issue of the displacement operability of a mouse, foot pads are installed at the bottom of the mouse, but conventional mouse pads still cannot overcome the issue of the displacement operability of the mouse. The conventional mouse pads either come with a poor performance or a high cost, and thus the prior art still requires further improvements.

In view of the foregoing shortcomings of the prior art, the inventor of the present invention based on years of experience in the related industry to conduct extensive researches and experiments, and finally developed a foot pad structure of a mouse with a low worn-out, durable, smooth mouse structure to overcome the shortcoming of the prior art.

### SUMMARY OF THE INVENTION

Therefore, it is a primary objective of the present invention to provide an improved foot pad structure of a mouse, and the use of the mouse features a low friction, a low worn-out and an easy sliding operation, and the smooth operation of the mouse has a better displacement operability to enhance practicability, cost effectiveness and product competitiveness.

To achieve the foregoing objective, the present invention provides an improved foot pad structure of a mouse, comprising: a mouse housing having a top surface and a bottom surface; at least one foot pad, installed at the bottom surface of the mouse housing, and the foot pad is made of a ceramic material or a glass material that provides the wear-resisting, low friction, low worn-out features.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a perspective top view of a mouse of the present invention;

FIG. 2 is a perspective bottom view of a mouse of the present invention; and

FIG. 3 is an exploded view of a portion of the present invention.

### DETAILED DESCRIPTION OF THE PREFERRED EMBODIMENTS

The technical characteristics of the present invention will become apparent in the following detailed description of the preferred embodiments with reference to the accompanying drawings.

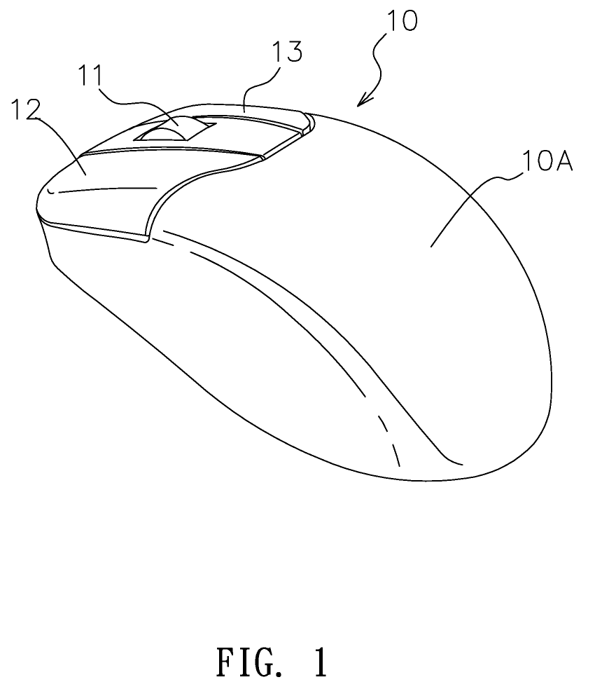

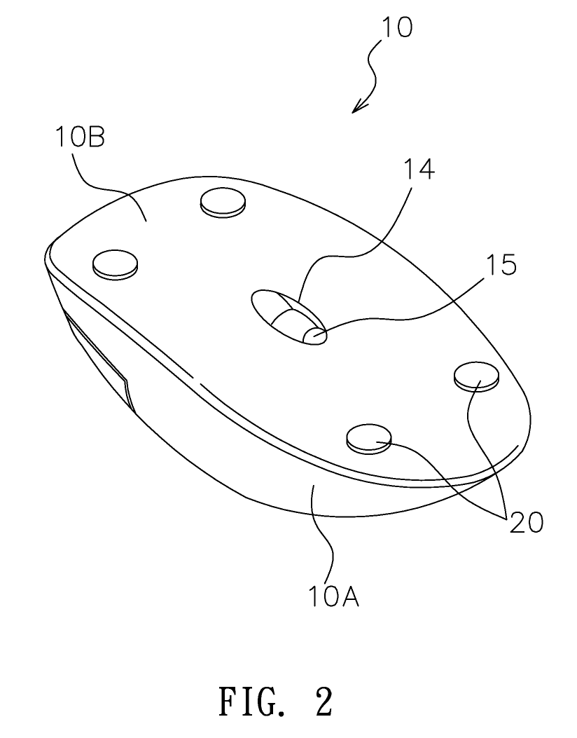

With reference to FIGS. 1 and 2, an improved foot pad structure of a mouse in accordance with the present invention comprises a mouse (which is an optical mouse in this embodiment, but not limited to the optical mouse only), and the mouse comprises a mouse housing 10 and at least one foot pad device 20, wherein an operating roller 11 is protruded from a top surface 10A of the mouse housing 10 and a press button 12, 13 disposed separately on both sides of the operating roller 11, and a through hole 14 (which is an optical or a laser through hole) disposed at a bottom surface 10B of the mouse housing 10 for projecting a light source 15 in the mouse housing 10, and the foot pad device 20 is made of a ceramic material that provides wear-resisting, low friction, low worn-out features, and the foot pad device 20 is disposed on the bottom surface 10B of the mouse housing 10.

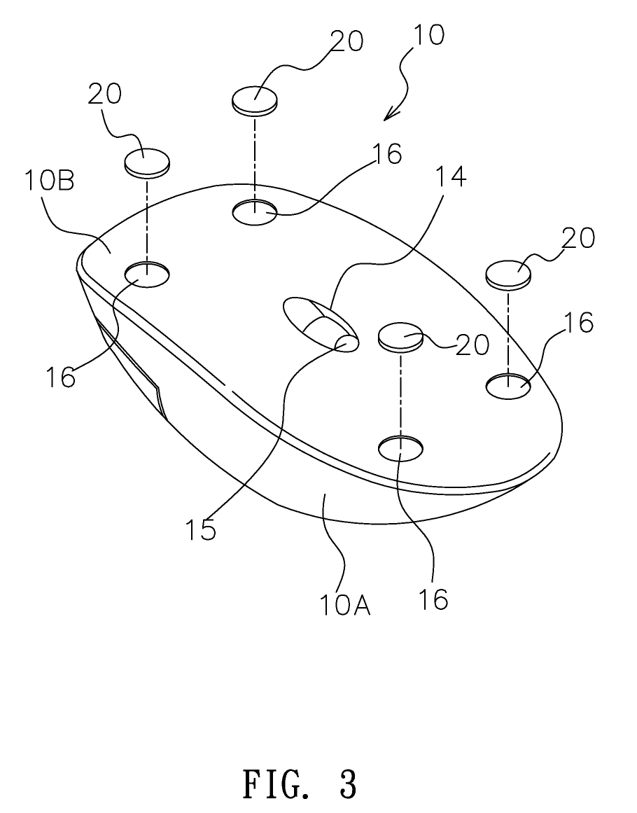

With reference to FIG. 3, the foot pad device 20 is adhered onto the bottom surface 10B of the mouse housing 10. In general, the bottom surface 10B of the mouse housing 10 includes a positioning slot 16, and the foot pad device 20 is adhered at the positioning slot 16. Further, the foot pad device 20 (not shown in the figure) can be embedded or fixed onto the bottom surface 10B of the mouse housing 10 by another method.

The foot pad device 20 is made of a ceramic material consisting of 88˜98% of zirconium oxide (ZrO₂) and 12˜2% of yttrium oxide (Y₂O₃/stabilizer), and the ceramic material consisted of the yttria stabilized zirconia in the foregoing composition ratio provides the wear-resisting, low friction, low worn-out features, and the injection molding method or sinter molding method is used for forming the foot pad device 20, such that the foot pad device 20 has physical properties of a Rockwell hardness of 89 (HRA89), a polishing degree of 0.4 and a friction coefficient of 0.3, and the ceramic material composed of zirconium oxide (ZrO₂) and yttrium oxide (Y₂O₃) stabilizer is consisted of 95% of zirconium oxide (ZrO₂) and 5% of yttrium oxide (Y₂O₃) in this preferred embodiment.

The ceramic material of the foot pad device 20 can be consisted of 87˜97% of silicon nitride (SiN₄) and 13˜3% of yttrium oxide (Y₂O₃/stabilizer), and the ceramic material with the aforementioned ratio provides wear-resisting, low friction, low worn-out features, and the ceramic material composed of silicon nitride (SiN₄) and yttrium oxide (Y₂O₃) is used for forming the foot pad device 20 by an injection molding method or a sinter molding method, such that the foot pad device 20 has physical properties of a Rockwell hardness of 93 (HRA93), a polishing degree of 0.4 and a friction coefficient of 0.2. The ceramic material composed of the silicon nitride (SiN₄) and yttrium oxide (Y₂O₃) stabilizer is consisted of 94% of silicon nitride (SiN₄) and 6% of yttrium oxide (Y₂O₃) in this preferred embodiment.

The foot pad device 20 can be made of a glass material consisting of 75%˜85% of silicon dioxide (SiO₂), 1.5%˜5.5% of aluminum oxide (Al₂O₃), 2.5%˜8.5% of sodium oxide (Na₂O), 5.5%˜10% of boron oxide (B₂O₃), and the glass material in the aforementioned ratio is used for forming the foot pad device 20 by a sinter molding method or an injection molding method to provide the wear-resisting, low friction, low worn-out features, wherein the glass material of the foot pad is consisted of 80% of silicon dioxide (SiO₂), 3% of aluminum oxide (Al₂O₃), 5.0% of sodium oxide (Na₂O), 13% of boron oxide (B₂O₃) in this preferred embodiment.

The foot pad of the mouse made by a ceramic material in accordance with the present invention provides a low friction, a low worn-out and an easy sliding operation, and thus the invention is useful, and the foot pad made of the ceramic material improves the displacement operability of the mouse, and the design also enhances the cost effectiveness and product competitiveness.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved foot pad structure of a mouse, comprising:
a mouse housing, having a top surface and a bottom surface;
at least one foot pad, disposed at said bottom surface of said mouse housing, and made of a ceramic material, for providing wear-resisting, low friction, and low worn-out features.

2. The improved foot pad structure of a mouse according to claim 1, wherein said foot pad is attached or embedded onto said bottom surface of said mouse housing.

3. The improved foot pad structure of a mouse according to claim 1, wherein said ceramic material of said foot pad is consisted of 88˜98% of zirconium oxide (ZrO₂) and 12˜2% of yttrium oxide (Y₂O₃), for forming yttria stabilized zirconia (YSZ).

4. The improved foot pad structure of a mouse according to claim 3, wherein said ceramic material composed of yttria stabilized zirconia (YSZ) is used for forming said foot pad by a sinter molding method or an injection molding method.

5. The improved foot pad structure of a mouse according to claim 1, wherein said foot pad has physical properties including a Rockwell hardness of 89 (HRA89), a polishing degree of 0.4 and a friction coefficient of 0.3.

6. The improved foot pad structure of a mouse according to claim 3, wherein said ceramic material of said foot pad is preferably consisted of 95% of zirconium oxide (ZrO₂) and 5% of yttrium oxide (Y₂O₃).

7. The improved foot pad structure of a mouse according to claim 1, wherein said ceramic material of said foot pad is consisted of 87˜97% of silicon nitride (SiN₄) and 13˜3% of yttrium oxide (Y₂O₃).

8. The improved foot pad structure of a mouse according to claim 7, wherein said ceramic material is used for forming said foot pad by a sinter molding method or an injection molding method, and said foot pad comes with physical properties of a Rockwell hardness of 93 (HRA93), a polishing degree of 0.4 and a friction coefficient of 0.2.

9. The improved foot pad structure of a mouse according to claim 7, wherein said foot pad is made of a ceramic material preferably consisted of 94% of silicon nitride (SiN₄) and 6% of yttrium oxide (Y₂O₃).

10. An improved foot pad structure of a mouse, comprising:
a mouse housing, having a top surface and a bottom surface;
at least one foot pad, disposed at said bottom surface of said mouse housing, and made of a glass material, for providing wear-resisting, low friction, and low worn-out features.

11. The improved foot pad structure of a mouse according to claim 10, wherein said glass material of said foot pad is consisted of 75%˜85% of silicon dioxide (SiO₂), 1.5%˜5.5% of aluminum oxide (Al₂O₃), 2.5%˜8.5% of sodium oxide (Na₂O), and 5.5%˜10% of boron oxide (B₂O₃).

12. The improved foot pad structure of a mouse according to claim 11, wherein said glass material forms said foot pad by a sinter molding method or an injection molding method.

13. The improved foot pad structure of a mouse according to claim 10, wherein said foot pad is made of a glass material preferably consisted of 80% of silicon dioxide (SiO₂), 3% of aluminum oxide (Al₂O₃), 5.0% of sodium oxide (Na₂O), and 13% of boron oxide (B₂O₃).
